(19) United States
(12) Patent Application Publication
(10) Pub. No.: US 2015/0380058 A1
(43) Pub. Date: Dec. 31, 2015

(54) METHOD, DEVICE, TERMINAL, AND SYSTEM FOR AUDIO RECORDING AND PLAYING

(71) Applicant: Xiaomi Inc., Beijing (CN)

(72) Inventors: Wei HAN, Beijing (CN); Lina XU, Beijing (CN); Wenlin WANG, Beijing (CN)

(73) Assignee: Xiaomi Inc.

(21) Appl. No.: 14/844,169

(22) Filed: Sep. 3, 2015

Related U.S. Application Data
(63) Continuation of application No. PCT/CN2014/076271, filed on Apr. 25, 2014.

(30) Foreign Application Priority Data
Jul. 30, 2013 (CN) 201310326033.0

(51) Int. Cl. G11B 27/34; G10L 21/12

(52) U.S. Cl. CPC G11B 27/34; G10L 21/12

(57) ABSTRACT

A recording method includes receiving a mark start instruction in a process of recording audio data and establishing a mark event according to the mark start instruction. The mark event is configured to mark the audio data. The method further includes recording at least one parameter of the mark event, receiving a mark end instruction, and ending recording of the at least one parameter of the mark event according to the mark end instruction to obtain a mark data structure.

### CROSS REFERENCE TO RELATED APPLICATIONS

This application is a Continuation Application of International Application No. PCT/CN2014/076271 with an international filing date of Apr. 25, 2014, which is based upon and claims priority to Chinese Patent Application No. 201310326033.0, filed on Jul. 30, 2013, the entire contents of which are incorporated herein by reference.

### TECHNICAL FIELD

The present disclosure relates to computer technologies and, more particularly, to a recording method, a playing method, and a device, terminal, and system for recording and/or playing.

### BACKGROUND

A terminal can be used to record voice information via audio recording. In a typical recording process, a microphone of the terminal is enabled to capture voice information in a scenario to obtain audio data. After the voice information in the scenario is recorded, it can be reproduced when the terminal plays the audio data. For example, a user may record, via the microphone, the content of a lecture given by a teacher. When the terminal plays the audio data, the content of the lecture is reproduced.

If the user needs to search for certain content in the audio data obtained via recording, the user may adjust the play progress of the audio data when listening to the audio data, and locate the predetermined content by repeatedly listening to the audio data.

### SUMMARY

In accordance with the present disclosure, there is provided a recording method. The recording method includes receiving a mark start instruction in a process of recording audio data and establishing a mark event according to the mark start instruction. The mark event is configured to mark the audio data. The method further includes recording at least one parameter of the mark event, receiving a mark end instruction, and ending recording of the at least one parameter of the mark event according to the mark end instruction to obtain a mark data structure.

Also in accordance with the present disclosure, there is provided a playing method. The method includes acquiring an audio file. The audio file includes audio data and at least one mark data structure corresponding to the audio data. The mark data structure records at least one parameter of a mark event, which is configured to mark the audio data. The method further includes labeling the mark event in a process of playing the audio data.

Also in accordance with the present disclosure, there is provided a recording device. The recording device includes a processor and a non-transitory computer-readable storage medium storing instructions. The instructions, when executed by the processor, cause the processor to receive a mark start instruction in a process of recording audio data and establish a mark event according to the mark start instruction. The mark event is configured to mark the audio data. The instructions further cause the processor to record at least one parameter of the mark event, receive a mark end instruction, and end recording of the at least one parameter of the mark event according to the mark end instruction to obtain a mark data structure.

Also in accordance with the present disclosure, there is provided a playing device. The playing device includes a processor and a non-transitory computer-readable storage medium storing instructions. The instructions, when executed by the processor, cause the processor to acquire an audio file. The audio file includes audio data and at least one mark data structure corresponding to the audio data. The mark data structure records at least one parameter of a mark event, which is configured to mark the audio data. The instructions further cause the processor to label the mark event in a process of playing the audio data.

It shall be appreciated that the above general description and the detailed description hereinafter are only illustrative, but not for limiting the present disclosure.

### BRIEF DESCRIPTION OF THE DRAWINGS

To clearly describe technical solutions of embodiments of the present disclosure, drawings that are to be referred for description of the embodiments are briefly described hereinafter. The drawings described hereinafter merely illustrate some embodiments of the present disclosure. Persons of ordinary skill in the art may also derive other drawings based on the drawings described herein.

FIG. 1 is a flowchart illustrating a recording method according to an exemplary embodiment of the present disclosure.

FIG. 2 is a flowchart illustrating a recording method according to another exemplary embodiment of the present disclosure.

FIG. 3 is a flowchart illustrating a playing method according to an exemplary embodiment of the present disclosure.

FIG. 4 is a flowchart illustrating a playing method according to another exemplary embodiment of the present disclosure.

FIG. 5 is a flowchart illustrating a playing method according to another exemplary embodiment of the present disclosure.

FIG. 6 is a structural block diagram illustrating a recording device according to an exemplary embodiment of the present disclosure.

FIG. 7 is a structural block diagram illustrating a recording device according to another exemplary embodiment of the present disclosure.

FIG. 8 is a structural block diagram illustrating a playing device according to an exemplary embodiment of the present disclosure.

FIG. 9 is a structural block diagram illustrating a playing device according to another exemplary embodiment of the present disclosure.

FIG. 10 is a structural block diagram illustrating a playing device according to another exemplary embodiment of the present disclosure.

FIG. 11 is a structural block diagram illustrating a terminal according to an exemplary embodiment of the present disclosure.

FIG. 12 is a structural block diagram illustrating an audio system according to an exemplary embodiment of the present disclosure.

The above drawings are used for illustrating the embodiments of the present disclosure, and more details will be given hereinafter. These drawings and textual descriptions are not intended to limit the scope defined in the present disclosure in any way, but intended to describe the inventive concept of the present disclosure, through specific embodiments, for a person skilled in the art.

### DETAILED DESCRIPTION

Embodiments of the present disclosure are described hereinafter in detail with reference to the attached drawings. Methods and devices consistent with embodiments of the present disclosure can be implemented in, for example, a recording terminal, such as a smart TV, a smart phone, or a tablet computer.

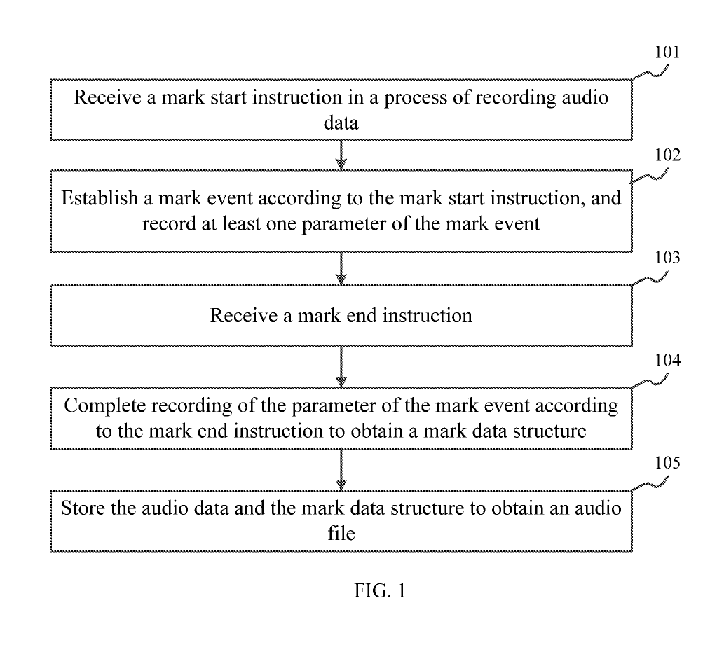

FIG. 1 is a flowchart illustrating a recording method according to an embodiment of the present disclosure. As shown in FIG. 1, at 101, a mark start instruction is received during a process of recording audio data. In the present disclosure, the audio data refers to data acquired by collecting voice information in a scenario. The mark start instruction is used to trigger marking of the audio data. The mark start instruction can be triggered by a user or automatically by the terminal.

At 102, a mark event is established according to the mark start instruction, and at least one parameter of the mark event is recorded. The mark event is used to mark the audio data. That is, the recording terminal triggers the establishment of the mark event according to the received mark start instruction. The mark event is used to mark the audio data, such that the audio data can be searched via a mark. For example, a certain audio segment in the audio data is marked.

At 103, a mark end instruction is received. The mark end instruction is used to trigger ending of the mark event. The mark end instruction can be triggered by the user or automatically by the terminal.

At 104, recording of the at least one parameter of the mark event is completed according to the mark end instruction to obtain a mark data structure. That is, the recording terminal ends the establishment of the mark event according to the received mark end instruction, and completes recording of the acquired at least one parameter of the mark event. In some embodiments, the mark event has more than one parameter. In some embodiments, all the parameters of the mark event are stored in one directory, and thus the mark data structure is obtained, in which the mark event is used as an index. This facilitates searching of the parameters of the mark event and improves the loading efficiency of the mark event.

According to the present disclosure, one or more mark events may be established. Therefore, in some embodiments, the recording terminal can store acquired parameters using the names of the parameters, hereinafter also referred to as “parameter names,” as indices. Parameters of all of the one or more mark events that are of the same type are stored in one directory.

At 105, the audio data and the mark data structure are stored as an audio file. That is, the recording terminal can store the audio data and the mark data structure together. Alternatively, in some embodiments, the terminal can separately store the audio data and the mark data structure, such that data of the same structure can be managed conveniently.

After storing the mark data structure, the recording terminal continues to detect whether a mark start instruction is received. If another mark start instruction is received, the recording terminal establishes another mark event. The audio file includes audio data obtained by recording and at least one mark data structure obtained in the process of recording the audio data. Each of the at least one mark data structure corresponds to one mark event.

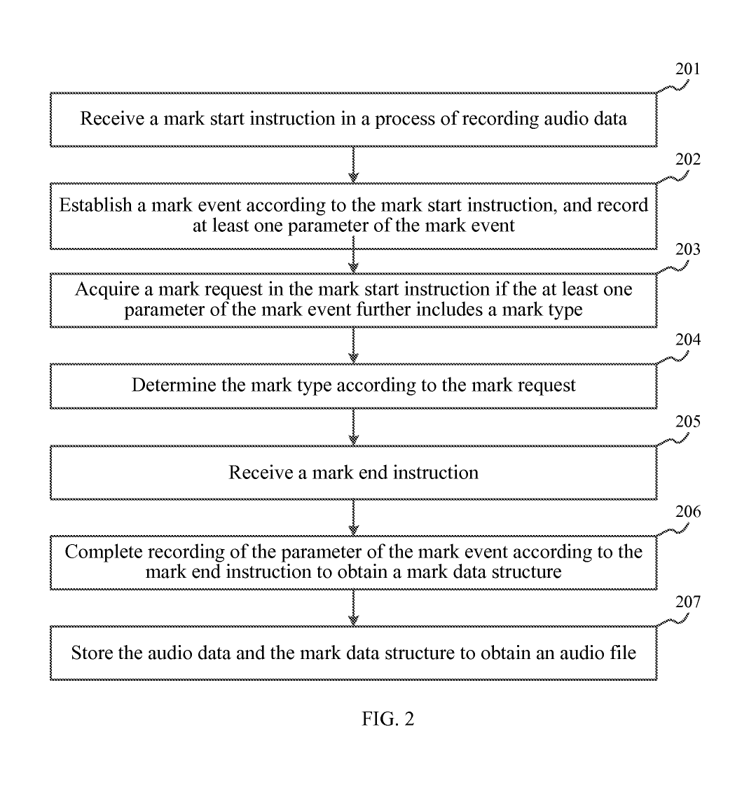

FIG. 2 is a flowchart illustrating a recording method according to another embodiment of the present disclosure. As shown in FIG. 2, at 201, a mark start instruction is received during a process of recording audio data. 201 is similar to 101 in FIG. 1 described above, and thus details thereof are omitted.

At 202, a mark event is established according to the mark start instruction, and at least one parameter of the mark event is recorded. The at least one parameter is recorded so that when the recorded audio data is played, the mark event can be loaded according to the at least one parameter.

In some embodiments, recording the at least one parameter of the mark event includes recording an event identifier (Event ID), an audio identifier (File ID), and a mark start time (Start Time). The event identifier is used to identify the mark event. The audio identifier is used to identify the audio data. The mark start time is used to record a recording time point of the audio data at which the mark event starts.

The event identifier “Event ID” can be assigned by a predetermined device, which can be the recording terminal or a device for managing the mark event, for example, a database, a server, or the like. The event identifier can be recorded at any time upon establishment of the mark event and before the establishment of the mark event is completed.

The audio identifier “File ID” can be determined by the predetermined device. The audio identifier can be a file name, a hash value obtained by a hash operation on the file name, or the like. The audio identifier can be recorded at any time upon establishment of the mark event and before the establishment of the mark event is completed.

The mark start time “Start Time” is a time point of establishing the mark event that is recorded by the recording terminal. The time point corresponds to a recording time point of the audio data. For example, if the mark event is established when the recording time of the audio data is at the third minute, then the mark start time is the time point at the third minute.

At 203, if the at least one parameter of the mark event further includes a mark type (Event Type), a mark request in the mark start instruction is acquired. The mark request is used to determine the type of the mark event. Since the audio data can be marked in different manners, the recording terminal can categorize the mark events into different types and configure the at least one parameter of the mark event according to the mark type, such that the at least one parameter more complies with the characteristics of the mark event.

In some embodiments, the recording terminal can acquire the mark request based on an action, for example, by the user. In some embodiments, the mark request can be carried in the mark start instruction and thus the mark request can be acquired from the mark start instruction.

At 204, the mark type is determined according to the mark request. The mark type includes at least one of an emphasis mark type or an insertion mark type.

If the mark type includes the emphasis mark type, the part of the audio data determined by the mark start time and the mark end time, which part is also referred to as “to-be-marked audio data,” is marked or highlighted, such as by generating a notification for a certain audio segment in the audio data. For example, if a notification is to be made for the audio segment in the audio data between the third minute and the fifth minute of the recording time, a play progress bar can be pre-loaded, and part of the progress bar between the third minute and the fifth minute is bolded, or the display color thereof is changed. Alternatively, the notification can be in another form, such as voice, picture, or text.

If the mark type includes the insertion mark type, a display event associated with the to-be-marked audio data is marked. For example, predetermined content can be displayed during the process of playing the audio data. The predetermined content may include pictures, texts, videos, or the like.

In some embodiments, the recording terminal can identify the mark type according to a predetermined value of “Event Type.” For example, the value of “Event Type” can be set to 0 to indicate an emphasis mark type, and set to 1 to indicate an insertion mark type.

Further, if the mark type includes the insertion mark type, the at least one parameter of the mark event may further include a storage path of the predetermined content (Event Path) or both the storage path and a predetermined display duration of the predetermined content. The storage path “Event Path” of the predetermined content is used to acquire the predetermined content that is inserted. The storage path can be, for example, a default storage path, a predetermined storage path, or a storage path contained in a file of a predetermined program that is used to acquire the predetermined content. For example, if the mark event includes an inserted picture, a camera may be invoked to capture a picture, and a path for storing the captured picture is determined as the storage path.

In some embodiments, the recording terminal can also set a predetermined display duration for the predetermined content. For example, the predetermined display duration can be a default display duration or a display duration set according to a user's inputs.

In some embodiments, the at least one parameter of the mark event may further include a remark, which is used to describe the mark event. The remark may be, for example, an event name of the mark event.

At 205, a mark end instruction is received. 205 is similar to 103 in FIG. 1 described above, and thus the details thereof are omitted.

At 206, recording of the at least one parameter of the mark event is completed according to the mark end instruction to obtain a mark data structure. In some embodiments, a mark end time (End Time) is recorded. The mark end time is used to record a recording time point of the audio data at the end of the mark event. For example, the establishment of the mark event is completed when the recording time of the audio data is the fifteenth minute. As such, the mark end time recorded by the recording terminal is the time point of the fifteenth minute.

According to the present disclosure, if the mark type is the insertion mark type, the mark end time may be the same as the mark start time. That is, the time point of the recorded mark start time can be read and recorded as the mark end time. Alternatively, the mark end time may be different from the mark start time. In this scenario, the time point at which the mark end instruction is received can be recorded as the mark end time.

Additional details of 206 are similar to those of 104 in FIG. 1 described above, and are thus not repeated.

At 207, the audio data and the mark data structure are stored as an audio file. 207 is similar to 105 in FIG. 1 described above, and thus the details thereof are omitted.

After storing the mark data structure, the recording terminal continues to detect whether a mark start instruction is received. If another mark start instruction is received, the recording terminal establishes another mark event. The audio file includes audio data obtained by recording and at least one mark data structure obtained in the process of recording the audio data. Each of the at least one mark data structure corresponds to one mark event.

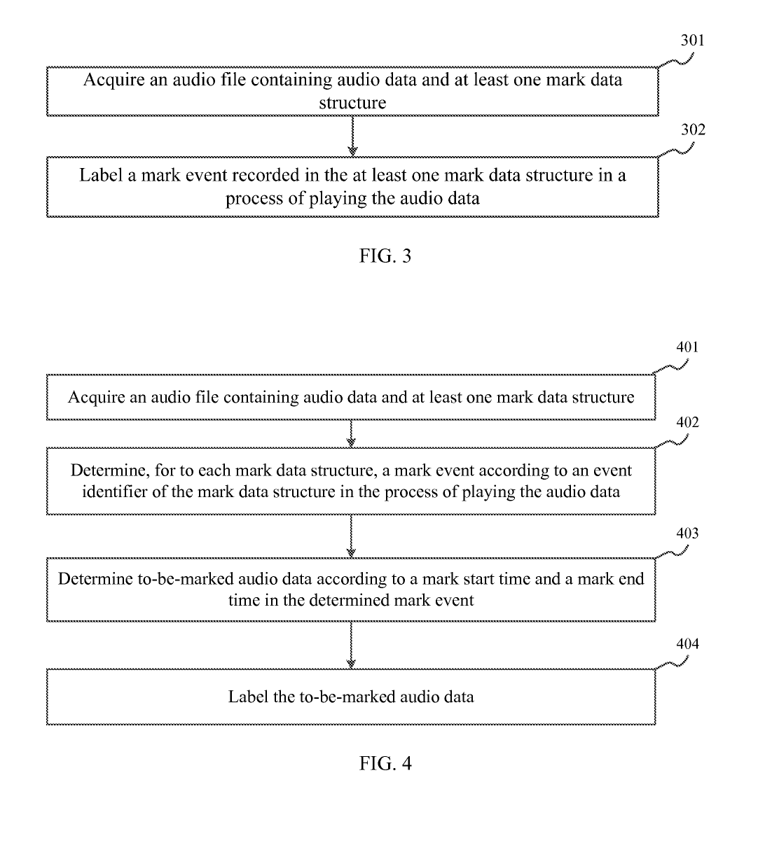

FIG. 3 is a flowchart illustrating a playing method according to an embodiment of the present disclosure. As shown in FIG. 3, at 301, an audio file is acquired. The audio file includes audio data and at least one mark data structure corresponding to the audio data. The mark data structure records at least one parameter of a mark event in a process of recording the audio data. The mark event marks the audio data.

The method for acquiring the audio file by the playing terminal depends on the manner of storing the audio file. For example, if the audio data and the mark data structure are stored together, the playing terminal may acquire both the audio data and the mark data structure. If the audio data and the mark data structure are separately stored, the playing terminal may first acquire the audio data, and then acquire the corresponding mark data structure according to the audio data.

At 302, the mark event recorded in the at least one mark data structure is labeled in a process of playing the audio data. That is, the playing terminal determines the mark event according to the acquired mark data structure, and labels the mark event in the process of playing the audio data. For example, a certain audio segment in the audio data is marked.

FIG. 4 is a flowchart illustrating a playing method according to another embodiment of the present disclosure. As shown in FIG. 4, at 401, an audio file is acquired. 401 is similar to 301 in FIG. 3, and thus includes the details of 301 described above.

Moreover, at 401, if audio data and mark data structures are separately stored, each mark data structure includes an audio identifier that identifies the audio data associated with that mark data structure. In this scenario, acquiring the audio file includes acquiring audio data and an audio identifier of the audio data, searching in the audio identifiers included in the mark data structures to locate an audio identifier identical to the audio identifier of the acquired audio data, and acquiring at least one mark data structure to which the located audio identifier pertains. By searching for a mark data structure corresponding to the acquired audio data, the playing terminal is able to determine whether the acquired audio data has a mark event.

In some embodiments, the recording terminal can generate and store the audio identifier in the process of recording the audio data. Further, the recording terminal can add the audio identifier to the mark data structure corresponding to the audio data, such that the playing terminal can acquire the audio identifier of the audio data upon selecting the audio data to be played.

At 402, for each acquired mark data structure, a mark event is determined according to the event identifier “Event ID” included in that mark data structure.

At 403, to-be-marked audio data is determined according to the mark start time and the mark end time in the determined mark event.

If the mark start time is different from the mark end time, the marked data is an audio segment. For example, if the mark start time is the time point of the third minute in the process of playing the audio data, and the mark end time is the time point of the fifth minute in the process of playing the audio data, then the to-be-marked audio data is an audio segment recorded between the third minute and the fifth minute.

If the mark start time is the same as the mark end time, the to-be-marked audio data is an audio point. For example, if the mark start time and the mark end time are both a time point of the sixth minute in the process of playing the audio data, then the to-be-marked audio data is an audio point at the sixth minute in the process of recording the audio data.

At 404, the to-be-marked audio data is labeled. That is, upon determining the to-be-marked audio data, the playing terminal labels the to-be-marked audio data according to the determined mark event.

As described above, the recording terminal can categorize the mark events, and record mark types of the mark events in the mark data structures. Therefore, the mark data structure acquired by the playing terminal further includes a mark type. The playing terminal thus also reads the mark type. If the read mark type includes the emphasis mark type, the playing terminal generates a particular notification for the to-be-marked audio data. On the other hand, if the read mark type includes the insertion mark type, the playing terminal displays predetermined content at a predetermined time. The predetermined time is a time between the mark end time of a previous mark event and the mark start time of a next mark event of the to-be-marked audio data.

In some embodiments, the playing terminal may determine the mark type “Event Type” according to a predetermined rule and a read value. For example, according to the predetermined rule, a value of 0 of “Event Type” indicates an emphasis mark type and a value of 1 of “Event Type” indicates an insertion mark type. Thus, if the value read by the playing terminal is 0, the playing terminal determines that the mark type is an emphasis mark type. On the other hand, if the value read by the playing terminal is 1, the playing terminal determines that the mark type is an insertion mark type.

If the mark type includes the emphasis mark type, a notification can be generated for a certain section of the audio in the audio data. For example, if a notification needs to be generated for the audio segment in the audio data between the third minute and the fifth minute in the recording time, the playing terminal can pre-load a play progress bar, and bold the part of the progress bar between the third minute and the fifth minute, or change the display color of that part. Alternatively, the playing terminal may generate the notification in another form, such as voice, picture, or text.

If the mark type includes the insertion mark type, predetermined content may be displayed in the process of playing the audio data. The predetermined content may include pictures, texts, videos, or the like. The playing terminal may display the predetermined content at a position corresponding a predetermined time point on the play progress bar. In some embodiments, the playing terminal may display the predetermined content in a full screen mode.

In some embodiments, if there is a previous mark event before the mark event, hereinafter also referred to as a “current mark event,” and a next mark event after the current mark event, the predetermined time can be any time between a display stop time of the previous mark event and a display start time of the next mark event. If there is no previous mark event before the current mark event, the predetermined time is any time before the display start time of the next mark event. If there is no next mark event after the current mark event, the predetermined time is any time after the display stop time of the previous mark event. In some embodiments, a display start time may be a mark start time, and a display stop time may be a mark end time.

In some embodiments, a predetermined display duration may be defined, such as, for example, a default display duration or a display duration defined according to the user's inputs. Therefore, the mark data structure may further include a predetermined display duration of the predetermined content. In this scenario, to display the predetermined content at the predetermined time, the playing terminal determines a first stop time that is later than the predetermined time for the predetermined display duration. If the first stop time is earlier than the mark start time of the next mark event, the playing terminal displays the predetermined content in a period from the predetermined time to the first stop time. On the other hand, if the first stop time is later than the mark start time of the next mark event, the playing terminal displays the predetermined content in a period from the predetermined time to a second stop time later than the predetermined time but earlier than or the same as the mark start time of the next mark event.

For example, if the predetermined display time is the thirtieth second in the process of playing the audio data and the predetermined display duration is fifty seconds, then the first stop time is the eightieth second in the process of playing the audio data. If the mark start time of the next mark event is the one-hundredth second, the predetermined content can be displayed until the first stop time. On the other hand, if the mark start time of the next mark event is the seventieth second in the process of playing the audio data, which is earlier than the eightieth second, then the second stop time can be set to any time within an time interval of (thirtieth second, seventieth second].

In some embodiments, the mark data structure further includes a storage path of the predetermined content. In this scenario, the playing method further includes acquiring the predetermined content according to the storage path. Details related to the storage path are described above in connection with the recording method and thus are not repeated here.

In some embodiments, the mark data structure further includes a remark used to describe the mark event. In this scenario, the displaying method furthers include reading the remark. The playing terminal may display the remark, such that the user can determine the mark event according to the remark. The remark may be, for example, an event name of the mark event.

In the process of playing the audio data by the playing terminal, for each mark data structure, 402 to 404 described above can be performed to label that mark event.

According to the present disclosure, the playing terminal can label the mark event in the process of loading the audio data or in the process of playing the to-be-marked audio data. If the mark event is labeled in the process of loading the audio data and the mark type includes the insertion mark type, a thumbnail of the predetermined content corresponding to the mark event can be displayed at a corresponding audio point.

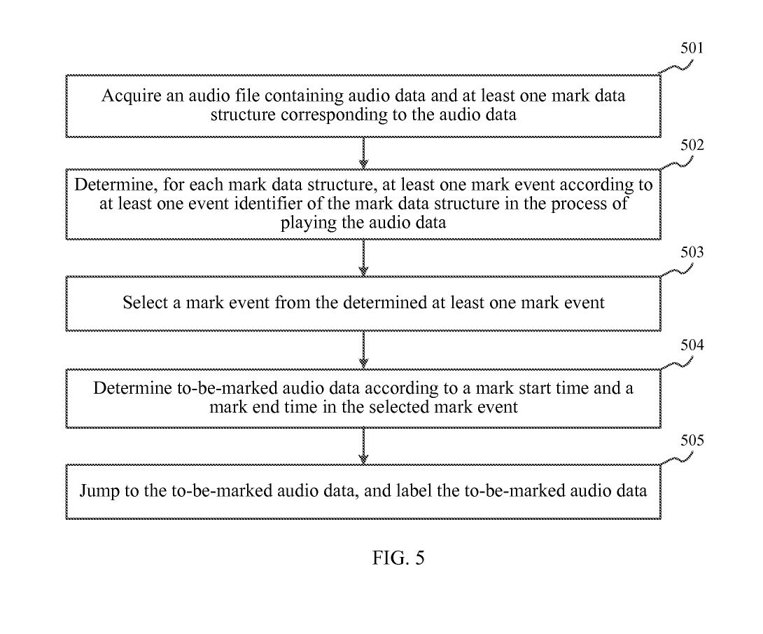

FIG. 5 is a flowchart illustrating a playing method according to another embodiment of the present disclosure. As shown in FIG. 5, at 501, an audio file is acquired. 501 is similar to 401 in FIG. 4 described above, and thus details thereof are omitted.

At 502, for each mark data structure, at least one mark event is determined according to at least one identifier “Event ID” included in the mark data structure.

At 503, a mark event is selected from the determined at least one mark event. That is, the playing terminal determines the mark events according to the event identifiers in the mark data structure, and presents all the determined mark events, such that the user can select a mark event from all the presented mark events for labeling.

At 504, to-be-marked audio data is determined according to the mark start time and the mark end time in the selected mark event. 504 is similar to 403 in FIG. 4 described above, and thus details thereof are omitted.

At 505, the to-be-marked audio data is jumped to, and the to-be-marked audio data is labeled. That is, the playing terminal acquires a link of the selected mark event, jumps to the to-be-marked audio data corresponding to the mark event according to the link, labels the to-be-marked audio data, and starts playing the to-be-marked audio data.

In some embodiments, the mark data structure may include a plurality of mark events of different mark types. Details of labeling audio data according to different mark types are described above in, e.g., the description of 404 in FIG. 4, and thus are not repeated here.

In some embodiments, a predetermined display duration may be defined. Details related to the predetermined display duration are described above in, e.g., the description of 404 in FIG. 4, and thus are not repeated here.

In some embodiments, the mark data structure further includes a storage path of the predetermined content. In this scenario, the playing method further includes acquiring the predetermined content according to the storage path.

In some embodiments, the mark data structure further includes a remark for describing the mark event. In this scenario, the playing method further includes reading the remark.

According to the present disclosure, the playing terminal may label the mark event in the process of loading the audio data, or in the process of playing the to-be-marked audio data. In some embodiments, the playing terminal only labels the selected mark event.

In accordance with the present disclosure, there is provided an audio file, such as the audio file described above. The audio file may be created according to a recording method consistent with embodiments of the present disclosure, such as the recording method illustrated in FIG. 1 or FIG. 2. The audio file includes audio data and at least one mark data structure corresponding to the audio data. The mark data structure records at least one parameter of at least one mark event corresponding to the audio data. The mark event is used to mark the audio data. The mark data structure has a one-to-one correspondence with the mark event.

In some embodiments, the mark data structure includes an event identifier, an audio identifier, a mark start time, and a mark end time for each mark event. The event identifier identifies the mark event. The audio identifier identifies the audio data. The mark start time records a start time point of the mark event. The mark end time records an end time point of the mark event. The event identifier has a value assigned by a predetermined device. The audio identifier may be a file name, a hash value obtained by a hash operation on the file name, or the like.

In some embodiments, the mark data structure further includes the mark type. The mark type includes at least one of an emphasis mark type or an insertion mark type, as described above.

In some embodiments, if the mark type includes the insertion mark type, the mark data structure further includes a storage path of the predetermined content, as described above.

In some embodiments, a predetermined display duration can be set, as described above.

In some embodiments, the mark data structure further includes a remark, as described above.

In accordance with the present disclosure, there is also provided a non-transitory computer-readable storage medium storing the above audio file.

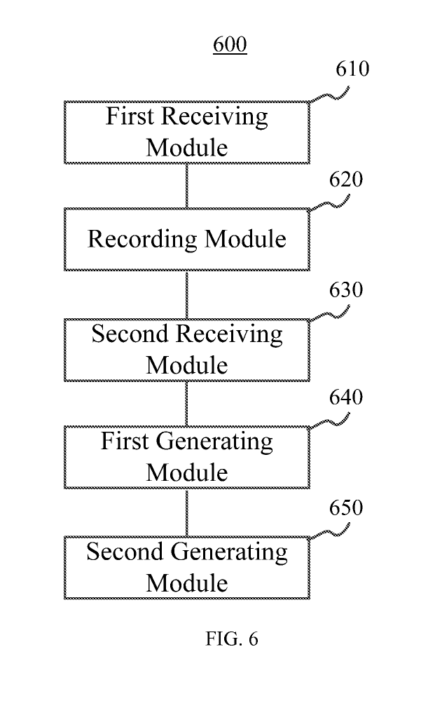

FIG. 6 is a structural block diagram illustrating a recording device 600 according to an embodiment of the present disclosure. The recording device 600 includes a first receiving module 610, a recording module 620, a second receiving module 630, a first generating module 640, and a second generating module 650.

The first receiving module 610 is configured to receive a mark start instruction in a process of recording audio data.

The recording module 620 is configured to establish a mark event according to the mark start instruction received by the first receiving module 610, and record at least one parameter of the mark event. The mark event is used to mark the audio data.

The second receiving module 630 is configured to receive a mark end instruction after the recording module 620 establishes the mark event and records the at least one parameter of the mark event.

The first generating module 640 is configured to complete recording of the at least one parameter of the mark event according to the mark end instruction received by the second receiving module 630 to obtain a mark data structure.

The second generating module 650 is configured to store the audio data and the mark data structure generated by the first generating module 640 to obtain an audio file.

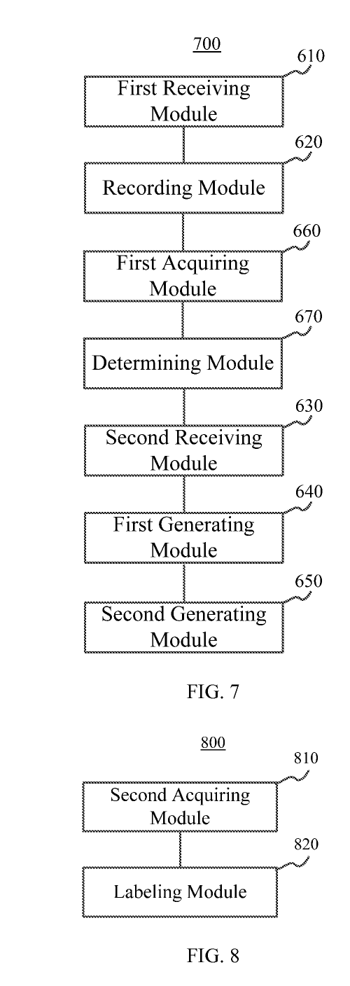

FIG. 7 is a structural block diagram illustrating a recording device 700 according to another embodiment of the present disclosure. The recording device 700 includes the first receiving module 610, the recording module 620, the second receiving module 630, the first generating module 640, the second generating module 650, a first acquiring module 660, and a determining module 670.

In some embodiments, the recording module 620 is further configured to record an event identifier, an audio identifier, and a mark start time. The event identifier is used to identify the mark event. The audio identifier is used to identify the audio data. The mark start time is used to record a recording time point of the audio data at which the mark event starts.

In some embodiments, the second generating module 650 is further configured to record a mark end time used to record a recording time point of the audio data at which the mark event ends.

The first acquiring module 660 is configured to acquire a mark request from the mark start instruction.

The determining module 670 is configured to determine the mark type according to the mark request acquired by the first acquiring module 660. Details relating to the mark type are described above, and are thus not repeated.

FIG. 8 is a structural block diagram illustrating a playing device 800 according to an embodiment of the present disclosure. The playing device 800 includes a second acquiring module 810 and a labeling module 820. The second acquiring module 810 is configured to acquire an audio file. The audio file includes audio data and at least one mark data structure corresponding to the audio data. The labeling module 820 is configured to label the mark event recorded in the at least one mark data structure in a process of playing the audio data acquired by the second acquiring module 810.

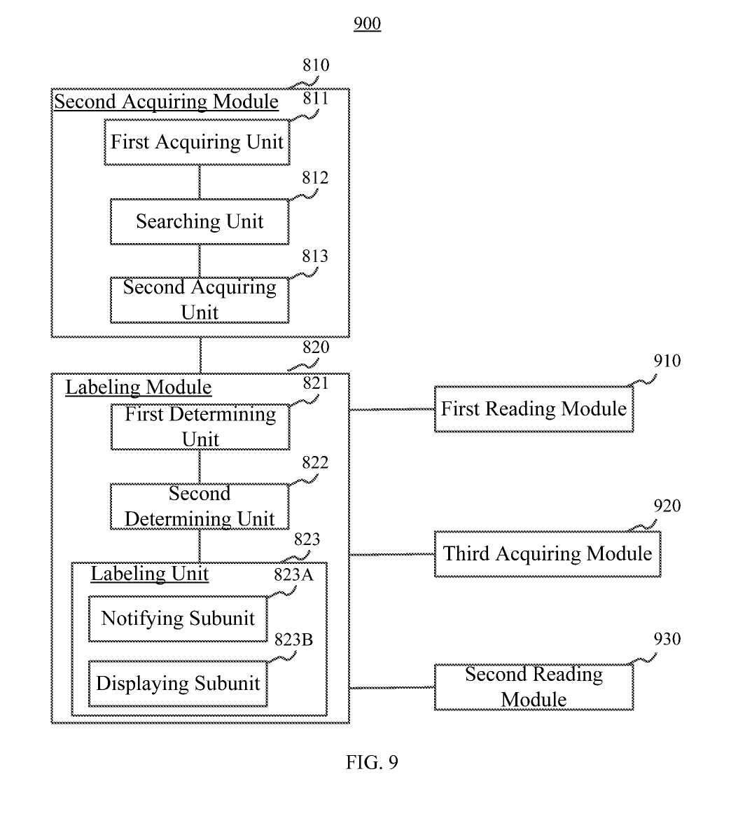

FIG. 9 is a structural block diagram illustrating a playing device 900 according to another embodiment of the present disclosure. The playing device 900 includes the second acquiring module 810 and the remarking module 820.

The mark data structure includes an audio identifier being used for identifying the audio data;

As shown in FIG. 9, the second acquiring module 810 includes a first acquiring unit 811, a searching unit 812, and a second acquiring unit 813. The first acquiring unit 811 is configured to acquire audio data and an audio identifier identifying the audio data. The searching unit 812 is configured to search in the audio identifiers included in the mark data structure to locate an audio identifier identical to the audio identifier of the audio data acquired by the first acquiring unit 811. The second acquiring unit 813 is configured to acquire at least one mark data structure which the audio identifier located by the searching unit 812 pertains.

As shown in FIG. 9, the labeling module 820 includes a first determining unit 821, a second determining unit 822, and a labeling unit 823. The first determining unit 821 is configured to, in the process of playing the audio data, determine the mark event according to an event identifier included in the mark data structure. The second determining unit 822 is configured to determine to-be-marked audio data according to a mark start time and a mark end time in the mark event determined by the first determining unit 821. The labeling unit 823 is configured to label the to-be-marked audio data determined by the second determining unit 822.

In some embodiments, as shown in FIG. 9, the device 900 further includes a first reading module 910 configured to read the mark type from the mark data structure. In these embodiments, as shown in FIG. 9, the labeling unit 823 includes a notifying subunit 823A and a displaying subunit 823B. The notifying subunit 823A is configured to, if the mark type read by the first reading module 910 includes an emphasis mark type, generate a particular notification for the to-be-marked audio data. The displaying subunit 823B is configured to, if the mark type read by the first reading module 910 includes an insertion mark type, display predetermined content at a predetermined time. The predetermined time is a time between a mark end time of a previous mark event and a mark start time of a next mark event of the to-be-marked audio data.

In some embodiments, as shown in FIG. 9, the device 900 further includes a third acquiring module 920 configured to acquire the predetermined content according to a storage path of the predetermined content.

In some embodiments, the displaying subunit 823B is further configured to determine a first stop time that is later than the predetermined time for a predetermined display duration included in the mark data structure, as described above.

In some embodiments, the device 900 further includes a second reading module 930 configured to read a remark from the mark data structure.

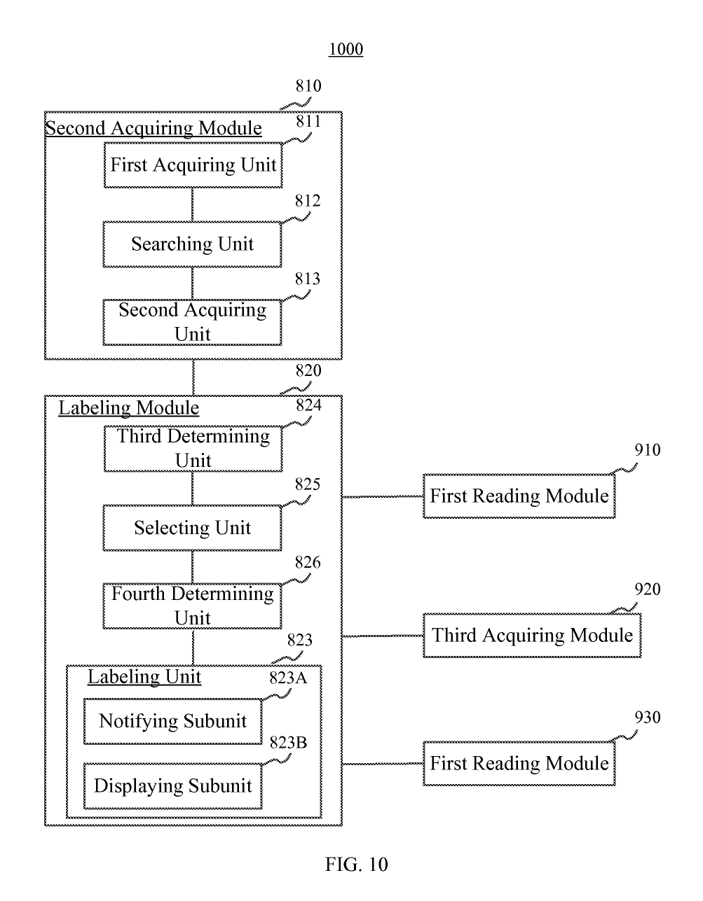

FIG. 10 is a structural block diagram illustrating a playing device 1000 according to another embodiment of the present disclosure. The playing device 1000 includes the second acquiring module 810 and the labeling module 820.

In some embodiments, as shown in FIG. 10, the second acquiring module 810 includes the first acquiring unit 811, the searching unit 812, and the second acquiring unit 813.

In some embodiments, as shown in FIG. 1000, the labeling module 820 includes the labeling unit 823, a third determining unit 824, a selecting unit 825, and a fourth determining unit 826. The third determining unit 824 is configured to, in the process of playing the audio data, determine at least one mark event according to at least one event identifier included in the mark data structure. The selecting unit 825 is configured to select a mark event from the at least one mark event determined by the third determining unit 824. The fourth determining unit 826 is configured to determine to-be-marked audio data according to a mark start time and a mark end time in the mark event selected by the selecting unit 825.

In some embodiments, the labeling unit 823 is further configured to jump to the to-be-marked audio data determined by the fourth determining unit 826, and label the to-be-marked audio data.

In some embodiments, as shown in FIG. 10, the device 1000 further includes the first reading module 910, the third acquiring module 920, and the second reading module 930. The labeling unit 823 includes the notifying subunit 823A and the displaying subunit 823B. Details of these modules and subunits are described above in connection with the device 900 shown in FIG. 9, and are thus not repeated.

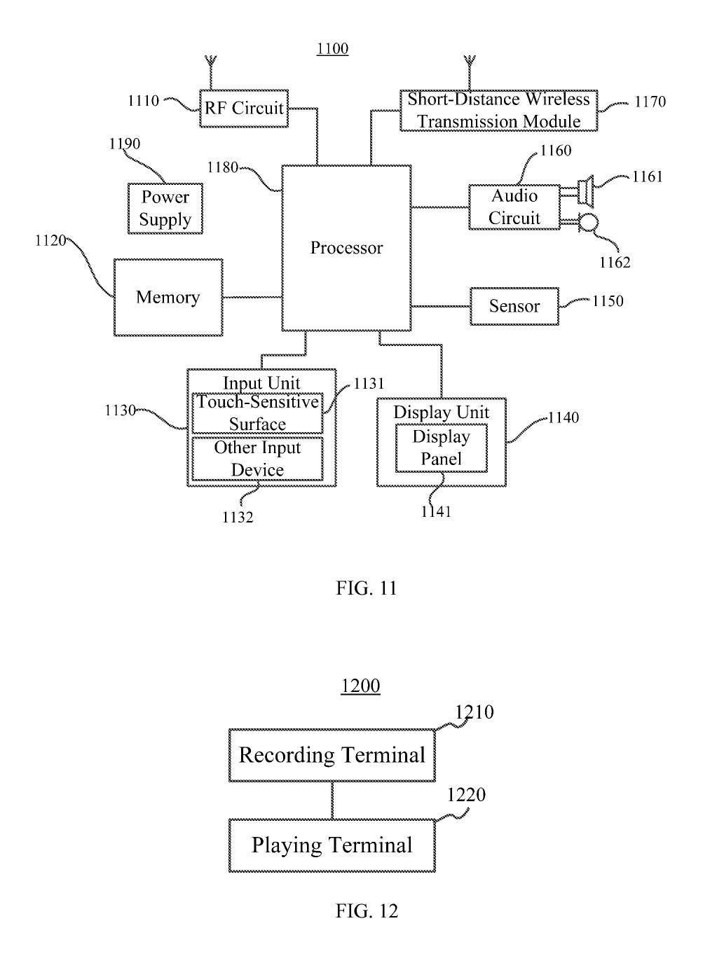

FIG. 11 is a structural block diagram of a terminal 1100 according to an embodiment of the present disclosure. The terminal 1100 can implement recording methods or playing methods consistent with embodiments of the present disclosure. The terminal 1100 includes one or more of the following components: a processor configured to run computer program instructions to implement various processes and methods; a random access memory (RAM) and a read-only memory (ROM) configured to store information and program instructions; a memory configured to store data and information, a database configured to store tables, directories or other data structures, an input/output (I/O) device, an interface, an antenna, and the like.

Specifically, as shown in FIG. 11, the terminal 1100 includes a radio frequency (RF) circuit 1110, a memory 1120 including at least one computer-readable storage medium, an input unit 1130, a display unit 1140, a sensor 1150, an audio circuit 1160, a short-distance wireless transmission module 1170, a processor 1180 having at least one processing core, a power supply 1190, or the like components. A person skilled in the art may understand that the structure of the terminal 1100 as illustrated in FIG. 11 does not construct a limitation on the terminal 1100. The terminal 1100 may include more or less components than those illustrated in FIG. 11, or combinations of some components, or employ different component deployments.

The RF circuit 1110 may be configured to receive and send signals during information receiving and sending or in the course of a call. Particularly, the RF circuit delivers downlink information received from a base station to the at least one processor 1180 for processing, and in addition, sends involved uplink data to the base station. Typically, the RF circuit 1110 includes, but not limited to, an antenna, at least one amplifier, a tuner, at least one oscillator, a subscriber identity module (SIM) card, a transceiver, a coupler, a low noise amplifier (LNA), a duplexer, and the like. In addition, the RF circuit 1110 may also communicate with a network or another device using wireless communication. The wireless communication may use any communication standard or protocol, including but not limited to: global system of mobile communication (GSM), general packet radio service (GPRS), code division multiple access (CDMA), wideband code division multiple access (WCDMA), long term evolution (LTE), email, short messaging service (SMS), and the like.

The memory 1120 may be configured to store software programs and modules. The processor 1180 executes the software programs and modules stored in the memory 1120 to perform various function applications and data processing. The memory 1120 mainly includes a program storage partition and a data storage partition. The program storage partition may store an operating system, at least one application for implementing a specific function (for example, audio playing function, image playing function, and the like). The data storage partition may store data created according to use of the terminal 1100 (for example, audio data, address book, and the like). In addition, the memory 1120 may include a high speed random access memory, or include a non-volatile memory, for example, at least one disk storage device, a flash memory device, or other non-volatile solid storage device. Correspondingly, the memory 1120 may further include a memory controller, for providing access to the memory 1120 for the processor 1180 and the input unit 1130.

The input unit 1130 may be configured to receive input numbers or characters, and generate signal input of a keyboard, a mouse, an operation rod, an optical or track ball related to user settings and function control. Specifically, the input unit 1130 may include a touch-sensitive surface 1131 and another input device 1132. The touch-sensitive surface 1131 is also referred to as a touch screen or a touch control plate, is capable of collecting a touch operation performed by a user thereon or therearound (for example, an operation performed by the user using fingers, touch pens, or other suitable objects or accessories on or around the touch-sensitive surface 1131), and drives a corresponding connection device according to a preset program. Optionally, the touch-sensitive surface 1131 may include a touch detecting device and a touch controller. The touch detecting device detects a touch azimuth of the user, detects a signal generated by the touch operation, and transmits the signal to the touch controller. The touch controller receives touch information from the touch detecting device, transforms the information into a touch point coordinate, sends the coordinate to the processor 1180, and receives a command issued by the processor 1180 and run the command. In addition, resistive, capacitive, infrared, and surface acoustic wave technologies may be used to implement the touch-sensitive surface 1131. In addition to the touch-sensitive surface 1131, the input unit 1130 may further include another input device 1132. Specifically, the another input device 1132 includes but not limited to at least one of a physical keyboard, a function key (for example, a volume control key, and a switch key), a track ball, a mouse, an operation rod, and the like.

The display unit 1140 may be configured to display information input by the user or information provided to the user, and various graphical user interfaces of the terminal 1100. These graphical user interfaces may be formed by graphics, texts, icons, and videos or any combination thereof. The display unit 1140 may include a display panel 1141. Optionally, the display panel 1141 may be configured by using a liquid crystal display (LCD), an organic light-emitting diode (OLED) or the like. Further, the touch-sensitive surface 1131 may cover the display panel 1141. When detecting a touch operation thereon on therearound, the touch-sensitive surface 1131 transfers the operation to the processor 1180 to determine the type of the touch event. Subsequently, the processor 1180 provides corresponding visual output on the display panel 1141 according to the type of the touch event. In FIG. 11, the touch-screen surface 1131 and the display panel 1141 are two independent components to implement input and output functions. However, in some embodiments, the touch-sensitive surface 1131 may be integrated with the display panel 1141 to implement the input and output functions.

The terminal 1100 may further include at least one sensor 1150, for example, a light sensor, a motion sensor, or another type of sensor. Specifically, the light sensor may include an ambient light sensor and a proximity sensor, where the ambient light sensor is capable of adjusting luminance of the display panel 1141 according to the intensity of the ambient light, and the proximity sensor is capable of shutting the display panel 1141 and/or backlight when the terminal 1100 is moved to the ears. As a type of motion sensor, a gravity sensor is capable of detecting the acceleration of each direction (typically three axes), and when in the static state, is capable of detecting the magnitude and direction of the gravity. The gravity sensor may be applicable to an application for recognizing mobile phone gestures (for example, switching between horizontal and vertical screens, relevant games, and magnetometer gesture calibration), and provide the vibration-based recognition function (for example, pedometers and knocks). The terminal 1100 may further include a gyroscope, a barometer, a hygrometer, a thermometer, and other sensors such as an infrared sensor, which are not described herein any further.

The audio circuit 1160, a loudspeaker 1161, and a microphone 1162 are capable of providing audio interfaces between the user and the terminal 1100. The audio circuit 1160 is capable of transmitting an electrical signal acquired by converting the received audio data to the loudspeaker 1161. The loudspeaker 1161 converts the electrical signal into a voice signal for output. In another aspect, the microphone 1162 converts the collected voice signals into the electrical signals, and the audio circuit 1160 converts the received electrical signals into audio data, and then outputs the audio data to the processor 1180 for processing. The processed audio data is transmitted by the RF circuit 1110 to another terminal; or the processed audio data is output to the memory 1120 for further processing. The audio circuit 1160 may further include an earphone plug for providing communication of an external earphone with the terminal 1100.

The short-distance wireless transmission module 1170 may be a wireless fidelity (WiFi) module, a Bluetooth module, or the like. The terminal 1100 facilitates user's receiving and sending emails, browsing web pages, and accessing streaming media, by using the short-distance wireless transmission module 1170 which provides wireless broadband Internet access services for users. Although FIG. 11 illustrates the short-distance wireless transmission module 1170, it may be understood that the short-distance wireless transmission module 1170 is not a necessary component for the terminal 1100, and may not be configured as required within the essence and scope of the present disclosure.

The processor 1180 is a control center of the terminal 1100, and connects all parts of the terminal by using various interfaces and lines, and implements various functions and data processing of the terminal 1100 to globally monitor the terminal, by running or performing software programs and/or modules stored in the memory 1120 and calling data stored in the memory 1120. Optionally, the processor 1180 may include at least one processing core. In an embodiment, the processor 1180 may integrate an application processor and a modem processor, where the application processor is mainly responsible for processing the operating system, user interface, and application program; and the modem processor is mainly responsible for performing wireless communication. It may be understood that the modem processor may also not be integrated in the processor 1180.

The terminal 1100 further includes the power supply 1190 (for example, a battery) supplying power for all the components. In an embodiment, the power supply may be logically connected to the processor 1180 by using a power management system, such that such functions as charging management, discharging management, and power consumption management are implemented by using the power management system. The power supply 1190 may further include at least one DC or AC power supply, a recharging system, a power fault detection circuit, a power converter or inverter, a power state indicator, and the like.

Although no detailed illustration is given, the terminal 1100 may further include a camera, a Bluetooth module, and the like, which are not described herein any further. In this embodiment, the display unit of the terminal 1100 is a touch screen display.

In addition to at least one processor 1180, the terminal 1100 further includes a touch screen, a memory, and at least one module, such as those described above. The at least one module is stored in the memory and configured to be executed by the at least one processor.

FIG. 12 is a structural block diagram of an audio system 1200 according to an embodiment of the present disclosure. The audio system includes a recording terminal 1210 and a playing terminal 1220. The recording terminal 1210 includes a recording terminal consistent with embodiments of the present disclosure, such as the terminal 600, 700, or 1100. The playing terminal 1220 includes a playing terminal consistent with embodiments of the present disclosure, such as the terminal 800, 900, 1000, or 1100.

It should be noted that, during recording and playing by the recording and playing devices according to the above embodiments, the devices are described only using division of the above functional modules as examples. In practice, the functions may be assigned to different functional modules for implementation as required. To be specific, the internal structures of the recording and playing devices are divided into different functional modules to implement all or part of the above-described functions. In addition, the recording and playing devices according to the above embodiments are based on the same inventive concept as the recording and playing methods according to the embodiments of the present disclosure. The specific implementation is elaborated in the method embodiments, which is not described herein any further.

The sequence numbers of the preceding embodiments of the present disclosure are only for ease of description, but do not denote the preference of the embodiments.

Persons of ordinary skill in the art should understand that all or part of the processes of the preceding embodiments may be implemented by hardware or hardware following instructions of programs. The programs may be stored in a non-transitory computer-readable storage medium. The storage medium may be a read only memory, a magnetic disk, or a compact disc.

Described above are merely exemplary embodiments of the present disclosure, but are not intended to limit the present disclosure. Any modification, equivalent replacement, or improvement made without departing from the spirit and principle of the present disclosure should fall within the protection scope of the present disclosure.

What is claimed is:

1. A recording method, comprising:
receiving a mark start instruction in a process of recording audio data;
establishing a mark event according to the mark start instruction, the mark event being configured to mark the audio data;
recording at least one parameter of the mark event;
receiving a mark end instruction; and
ending recording of the at least one parameter of the mark event according to the mark end instruction, to obtain a mark data structure.

2. The recording method according to claim 1, wherein:
recording the at least one parameter includes recording an event identifier, an audio identifier, and a mark start time, the event identifier being configured to identify the mark event, the audio identifier being configured to identify the audio data, and the mark start time being configured to record a first recording time point of the audio data at which the mark event starts; and
ending recording of the at least one parameter includes recording a mark end time, the mark end time being configured to record a second recording time point of the audio data at which the mark event ends.

3. The recording method according to claim 2, further comprising:
acquiring a mark request from the mark start instruction; and
determining a mark type according to the mark request, the mark type including at least one of:
an emphasis mark type indicating marking to-be-marked audio data determined between the mark start time and the mark end time, or
an insertion mark type indicating marking a display event of the to-be-marked audio data, the display event including displaying predetermined content.

4. The recording method according to claim 3, further comprising:
acquiring a storage path of the predetermined content, or
acquiring both the storage path and a predetermined display duration of the predetermined content.

5. A playing method, comprising:
acquiring an audio file, the audio file including audio data and at least one mark data structure corresponding to the audio data, the mark data structure recording at least one parameter of a mark event, and the mark event being configured to mark the audio data; and
labeling the mark event in a process of playing the audio data.

6. The playing method according to claim 5, wherein acquiring the audio file includes:
acquiring the audio data and an audio identifier corresponding to the audio data;
acquiring at least one stored mark data structure, each of the at least one stored mark data structure containing a recorded audio identifier;
searching the at least one stored mark data structures to locate a recorded audio identifier identical to the acquired audio identifier corresponding to the audio data; and
acquiring the at least one mark data structure from the at least one stored mark data structure according to the located recorded audio identifier.

7. The playing method according to claim 6, wherein labeling the mark event includes:
determining, in the process of playing the audio data, the mark event according to an event identifier included in the mark data structure;
determining to-be-marked audio data according to a mark start time and a mark end time corresponding to the mark event; and
labeling the to-be-marked audio data.

8. The playing method according to claim 6, wherein labeling the mark event includes:
determining, in the process of playing the audio data, at least one mark event according to at least one event identifier included in the mark data structure;
selecting the mark event from the determined at least one mark event;
determining to-be-marked audio data according to a mark start time and a mark end time corresponding to the selected mark event; and
jumping to and labeling the to-be-marked audio data.

9. The playing method according to claim 6, further comprising:
reading a mark type from the mark data structure, the mark type including at least one of:
an emphasis mark type indicating marking to-be-marked audio data determined between a mark start time and a mark end time, or
an insertion mark type indicating marking a display event of the to-be-marked audio data, the display event including displaying predetermined content,
wherein labeling the mark event includes:
generating, if the read mark type includes the emphasis mark type, a notification for the to-be-marked audio data; or
displaying, if the read mark type includes the insertion mark type, the predetermined content at a predetermined time, the predetermined time being a time between a mark end time of a previous mark event before the to-be-marked audio data and a mark start time of a next mark event after the to-be-marked audio data.

10. The playing method according to claim 9, wherein displaying the predetermined content at the predetermined time includes:
determining a first stop time that is later than the predetermined time for a predetermined display duration included in the mark data structure; and
displaying, if the first stop time is earlier than the mark start time of the next mark event, the predetermined content from the predetermined time to the first stop time; or
displaying, if the first stop time is later than the mark start time of the next mark event, the predetermined content from the predetermined time to a second stop time, the second stop time being later than the predetermined time but earlier than or same as the mark start time of the next mark event.

11. A recording device, comprising:
a processor; and
a non-transitory computer-readable storage medium storing instructions that, when executed by the processor, cause the processor to:
receive a mark start instruction in a process of recording audio data;
establish a mark event according to the mark start instruction, the mark event being configured to mark the audio data;
record at least one parameter of the mark event;
receive a mark end instruction; and
end recording of the at least one parameter of the mark event according to the mark end instruction, to obtain a mark data structure.

12. The recording device according to claim 11, wherein the instructions further cause the processor to:
record an event identifier, an audio identifier, and a mark start time, the event identifier being configured to identify the mark event, the audio identifier being configured to identify the audio data, and the mark start time being configured to record a first recording time point of the audio data at which the mark event starts; and
record a mark end time, the mark end time being configured to record a second recording time point of the audio data at which the mark event ends.

13. The recording device according to claim 12, wherein the instructions further cause the processor to:
acquire a mark request from the mark start instruction; and
determine a mark type according to the mark request, the mark type including at least one of:
an emphasis mark type indicating marking to-be-marked audio data determined between the mark start time and the mark end time, or
an insertion mark type indicating marking a display event of the to-be-marked audio data, the display event including displaying predetermined content.

14. The recording device according to claim 13, wherein the instructions further cause the processor to:
acquire a storage path of the predetermined content, or
acquire both the storage path and a predetermined display duration of the predetermined content.

15. A playing device, comprising:
a processor; and
a non-transitory computer-readable storage medium storing instructions that, when executed by the processor, cause the processor to:
acquire an audio file, the audio file including audio data and at least one mark data structure corresponding to the audio data, the mark data structure recording at least one parameter of a mark event, and the mark event being configured to mark the audio data; and
label the mark event in a process of playing the audio data.

16. The playing device according to claim 15, wherein the instructions further cause the processor to:
acquire the audio data and an audio identifier corresponding to the audio data;
acquire at least one stored mark data structure, each of the at least one stored mark data structure containing a recorded audio identifier;
search the at least one stored mark data structures to locate a recorded audio identifier identical to the acquired audio identifier corresponding to the audio data; and
acquire the at least one mark data structure from the at least one stored mark data structure according to the located recorded audio identifier.

17. The playing device according to claim 16, wherein the instructions further cause the processor to:
determine, in the process of playing the audio data, the mark event according to an event identifier included in the mark data structure;
determine to-be-marked audio data according to a mark start time and a mark end time corresponding to the mark event; and
label the to-be-marked audio data.

18. The playing device according to claim 16, wherein the instructions further cause the processor to:
determine, in the process of playing the audio data, at least one mark event according to at least one event identifier included in the mark data structure;
select the mark event from the determined at least one mark event;
determine to-be-marked audio data according to a mark start time and a mark end time corresponding to the selected mark event; and
jump to and label the to-be-marked audio data.

19. The playing device according to claim 16, wherein the instructions further cause the processor to:
read a mark type from the mark data structure, the mark type including at least one of:
an emphasis mark type indicating marking to-be-marked audio data determined between a mark start time and a mark end time, or
an insertion mark type indicating marking a display event of the to-be-marked audio data, the display event including displaying predetermined content; and
generate, if the read mark type includes the emphasis mark type, a notification for the to-be-marked audio data; or
display, if the read mark type includes the insertion mark type, the predetermined content at a predetermined time, the predetermined time being a time between a mark end time of a previous mark event before the to-be-marked audio data and a mark start time of a next mark event after the to-be-marked audio data.

20. The playing device according to claim 19, wherein the instructions further cause the processor to:
determine a first stop time that is later than the predetermined time for a predetermined display duration included in the mark data structure; and
display, if the first stop time is earlier than the mark start time of the next mark event, the predetermined content from the predetermined time to the first stop time; or
display, if the first stop time is later than the mark start time of the next mark event, the predetermined content from the predetermined time to a second stop time, the second stop time being later than the predetermined time but earlier than or same as the mark start time of the next mark event.
